(19) United States
(12) Patent Application Publication
(10) Pub. No.: US 2014/0189757 A1
(43) Pub. Date: Jul. 3, 2014

(54) METHOD AND SYSTEM FOR PROVIDING COMMENTARY

(71) Applicant: Brian Michael Segal, Muizenberg (ZA)

(72) Inventor: Brian Michael Segal, Muizenberg (ZA)

(73) Assignee: BMS TRUST, Muizenberg (ZA)

(21) Appl. No.: 14/118,362

(22) PCT Filed: May 18, 2012
(86) PCT No.: PCT/IB2012/052505

§ 371 Date: Mar. 12, 2014

(30) Foreign Application Priority Data
May 18, 2011 (ZA) 2011/02257

(51) Int. Cl. H04H 20/62

(52) U.S. Cl. CPC H04H 20/62
USPC 725/75

(57) ABSTRACT

The invention discloses a system having electronic means for providing commentary audibly and/or visually, which electronic means is adapted to provide such commentary asynchronously. The system includes multiple asynchronous group triggering on channels. The commentary is divided into channels and/or groups and includes plays based on areas, and not on sequence only. The plays and/or areas are sequenced if required and are provided with associated rules.

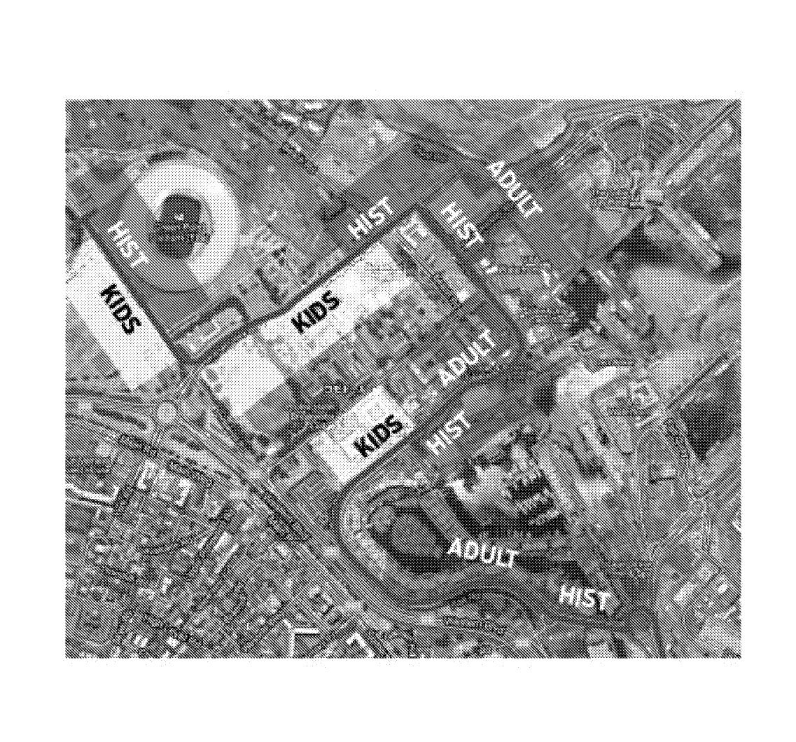

### FIELD OF INVENTION

The present invention relates to a method and system for providing commentary.

More particularly, the present invention relates to a method and system for providing commentary for the tourism industry.

### BACKGROUND TO INVENTION

Various tourism commentary systems are known and available in the world, in particular for tourism buses. These include multiple-language multiple-route systems and areas adapted to provide digital commentary content to flow through headphones in various languages. These systems are wired or wireless and GPS or driver-triggered. Furthermore the commentary systems can be adapted to provide multiple-themed audio-tracks thereby allowing tourists travelling the same route to select and hear selected topics or themes regarding a site such as sporting, cultural or religious themes in a selected language.

The known commentary systems are sequentially operated, i.e. all channels or languages are triggered at the same time. This is called synchronous triggering. These traditional or existing multilingual systems were developed along the lines of the driver selecting a play list and then manually by means of a “footswitch” or button playing each track. This resulted in the tracks needing to be played very sequentially.

With the development of GPS, the “footswitch” was replaced by a GPS trigger area, though the sound clips still had to be played sequentially. Drivers were now given the option of selecting individual clips to play if they got stuck in traffic or had to go on a detour.

It is an object of the invention to provide a method and system for providing commentary which will assist in improving the afore-mentioned problems.

### SUMMARY OF INVENTION

According to the invention, a system having electronic means for providing commentary audibly and/or visually, which electronic means is adapted to provide such commentary asynchronously.

Also according to the invention, a method for providing commentary audibly and/or visually by way of electronic means, includes the step of providing such commentary in an asynchronous manner.

Yet further according to the invention, a system having electronic means for providing commentary audibly and/or visually, which electronic means is adapted to provide commentary and which is adapted to be asynchronously triggered.

The system may include multiple asynchronous group triggering on channels.

The commentary may be divided into channels and/or groups.

The channels and/or groups may relate to kids, history, pop culture, sport, religion, politics, etc.

The commentary may include plays based on areas, and not on sequence only.

The plays and/or areas may be sequenced if required.

The plays and/or areas may be provided with associated rules.

The plays may include commentary plays and filling plays.

The areas may have various shapes, including rectangular, circular, polygonal, based on a single road/route.

The system may be adapted to prevent unwanted overlapping or conflicting of areas.

The preventing of overlapping of areas may be achieved by polygonal shaped areas.

The associated rules may include at least one of the following:
(a) Time delay;
(b) Speed rules;
(c) Direction rules using bearing;
(d) Timing;
(e) Triggering determined by:
   i. Entering an area;
   ii. Exiting an area;
   iii. While in an area;
(f) Priority rules;
(g) Only if time.

The rules may be adapted to be changed and/or optimised.

The system may be adapted to adapt the rules by means of a complex adaptive system.

### BRIEF DESCRIPTION OF DRAWING

The invention will now be described by way of example with reference to the accompanying schematic drawing.

In the drawing there is shown a conceptual layout design of the method and system for providing commentary illustrating triggering system zones in accordance with the invention.

### DETAILED DESCRIPTION OF DRAWING

Referring to the drawing, a conceptual layout design of the method and system for providing commentary illustrating triggering system zones in accordance with the invention is shown.

In accordance with the invention, there is provided a system having electronic means for providing commentary audibly and/or visually, which electronic means is adapted to provide such commentary asynchronously.

The commentary system includes multiple asynchronous group triggering means to trigger the commentary asynchronously.

The commentary is divided into channels and groups.

The groups and channels generally relate to kids, history, pop culture, sport, religion, politics, etc.

The commentary includes plays based on areas, and not on sequence only. Though the plays and areas can be sequenced if required.

The plays and areas are provided with associated rules.

The plays include commentary plays and filling plays.

The areas have various shapes, including rectangular, circular, polygonal, based on a single road/route. For example an area may be defined on a specific road, such as Long Street or only a section of Long Street, or De Waal Drive or Chapman's Peak Drive in the Cape.

The system can be adapted to prevent unwanted overlapping or conflicting of areas. This can be achieved by polygonal shaped areas.

The associated rules include at least one of the following:
(a) Time delay—will only play after x seconds of silence;
(b) Speed rules—e.g. in slow or fast traffic;
(c) Direction rules using bearing—e.g. from south, north etc.;
(d) Timing including day of week, time of day, season, etc.;
(e) Triggering is determined by:
   i. Entering an area (e.g. single shot only if no other play was playing);
   ii. Exiting an area;
   iii. While in an area (e.g. will play when the other play has finished playing);
(f) Priority rules (e.g. 3 levels of priority: high, medium, low). For example a medium play will interrupt a low play, and a high play will interrupt a medium play and a low play;
(g) Only if time allows—e.g. predicts the time from where the system is to the next trigger point and will only play the filling plays if time allows it to.

The rules can be adapted to be changed and/or optimised. Ideally the system is capable to adapt the rules by means of a complex adaptive system.

1. A system having electronic means for providing commentary audibly and/or visually, which electronic means is adapted to provide such commentary asynchronously.

2. A system as claimed in claim 1, which includes multiple asynchronous group triggering on channels.

3. A system as claimed in claim 1, in which the commentary is divided into channels and/or groups.

4. A system as claimed in claim 3, in which the channels and/or groups relate to kids, history, pop culture, sport, religion, politics, etc.

5. A system as claimed in claim 1, in which the commentary includes plays based on areas, and not on sequence only.

6. A system as claimed in claim 5, in which the plays and/or areas are sequenced if required and/or provided with associated rules.

7. (canceled)

8. A system as claimed in claim 5, in which the plays include commentary plays and filling plays.

9. A system as claimed in claim 5, in which the areas have various shapes, including rectangular, circular, polygonal, based on a single road/route.

10. A system as claimed in claim 1, which is adapted to prevent unwanted overlapping or conflicting of areas.

11. A system as claimed in claim 10, in which the preventing of overlapping of areas is achieved by polygonal shaped areas.

12. A system as claimed in claim 7, in which the associated rules include at least one of the following:
(a) Time delay;
(b) Speed rules;
(c) Direction rules using bearing;
(d) Timing;
(e) Triggering determined by:
i. Entering an area;
ii. Exiting an area;
iii. While in an area;
(f) Priority rules; and/or
(g) Only if time.

13. A system as claimed in claim 7, in which the rules are adapted to be changed and/or optimised.

14. A system as claimed in claim 7, which is adapted to adapt the rules by means of a complex adaptive system.

15. A method for providing commentary audibly and/or visually by way of electronic means, includes the step of providing such commentary in an asynchronous manner.

16-19. (canceled)

20. A method as claimed in claim 19, which includes the step of sequencing the plays and/or areas if required.

21. A method as claimed in claim 19, which includes the step of providing the plays and/or areas with associated rules.

22. (canceled)

23. A method as claimed in claim 19, in which the areas have various shapes, including rectangular, circular, polygonal, based on a single road/route.

24. A method as claimed in claim 15, which includes the step of preventing unwanted overlapping or conflicting of areas.

25-28. (canceled)

29. A system having electronic means for providing commentary audibly and/or visually, which electronic means is adapted to provide commentary and which is adapted to be asynchronously triggered.

30. A system as claimed in claim 29, which includes multiple asynchronous group triggering on channels.

31-44. (canceled)
